(19) United States
(12) Patent Application Publication
(10) Pub. No.: US 2026/0253979 A1
(43) Pub. Date: Aug. 27, 2026

(54) PORTABLE ELECTRONIC DEVICE AND SMART CHARGING METHOD THEREOF

(71) Applicant: ASUSTeK COMPUTER INC., Taipei City (TW)

(72) Inventor: Chih-Hsien Yang, Taipei City (TW)

(73) Assignee: ASUSTeK COMPUTER INC., Taipei City (TW)

(21) Appl. No.: 19/533,270

(22) Filed: Feb. 8, 2026

(30) Foreign Application Priority Data
Feb. 26, 2025 (TW) 114107173

(51) Int. Cl. H01M 10/44; G06F 1/3212; G06F 1/3228; G06F 1/3234

(52) U.S. Cl. CPC H01M 10/44; G06F 1/3212; G06F 1/3228; G06F 1/3265

(57) ABSTRACT

A portable electronic device and a smart charging method thereof are provided. The method is adapted to the portable electronic device including a battery and includes the following steps. A scheduled event within a predefined time period is detected. When the scheduled event within the predefined period is detected, whether remaining battery charge of the battery is less than a charge threshold is determined. If the remaining battery charge is less than the charge threshold, a charging parameter is determined based on event information of the scheduled event. The battery is controlled to perform charging according to the charging parameter.

### CROSS-REFERENCE TO RELATED APPLICATION

This application claims the priority benefit of Taiwan application serial no. 114107173, filed on Feb. 26, 2025. The entirety of the above-mentioned patent application is hereby incorporated by reference herein and made a part of this specification.

### BACKGROUND

### Technical Field

The disclosure relates to a portable electronic device and a smart charging method thereof.

### Related Art

As technology advances, portable electronic devices such as laptops and smartphones are becoming increasingly popular. In addition, to facilitate user operation in environments without power supply, rechargeable batteries are typically configured in portable electronic devices to provide power to the portable electronic device in environments without power supply. For example, when a laptop is not connected to an external power supply, the user must rely on battery power to maintain the operation of the laptop. The battery has a limited lifespan, and each charging reduces the battery's lifespan. The more charging cycles, the shorter the battery's usable life becomes. If one wants to make the battery last longer and avoid replacing it too soon, an effective way is to reduce the amount of power charged each time. However, relatively, because each charge is less than one hundred percent of power, users may easily face insufficient power or need to charge the device more frequently. Therefore, users need to balance between extending battery life and the usage time after a single charge (for example, how many hours it can be used).

### SUMMARY

The disclosure provides a smart charging method, applicable to a portable electronic device including a battery, and includes the following steps. A scheduled event is detected within a preset time period. Whether remaining capacity of the battery is below a battery capacity threshold is determined when the scheduled event within the preset time period is detected. A charging parameter is determined according to event information of the scheduled event when the remaining capacity of the battery is below the battery capacity threshold. The battery is controlled to perform a charging operation according to the charging parameter.

The disclosure also provides a portable electronic device, which includes a battery, a storage device, and a processor. The storage device records multiple instructions, and the processor is coupled to the battery and the storage device, executing the instructions to perform the following steps. A scheduled event is detected within a preset time period. Whether remaining capacity of the battery is below a battery capacity threshold is determined when the scheduled event within the preset time period is detected. A charging parameter is determined according to event information of the scheduled event when the remaining capacity of the battery is below the battery capacity threshold. The battery is controlled to perform a charging operation according to the charging parameter.

Based on the above, in the disclosure, when a scheduled event within the preset time period is detected, it may be determined whether the remaining capacity of the battery is sufficient for the portable electronic device to complete the scheduled event. Further, when it is determined that the remaining capacity of the battery is insufficient for the portable electronic device to complete the scheduled event, a charging parameter may be determined according to event information of the scheduled event, so that the battery may be charged according to this charging parameter. Thus, in the embodiment of the disclosure, the remaining available time of the battery device can be ensured to meet the target requirement.

### BRIEF DESCRIPTION OF THE DRAWINGS

FIG. 1 is a schematic diagram of a portable electronic device according to an embodiment of the disclosure.

FIG. 2 is a flowchart of a smart charging method according to an embodiment of the disclosure.

FIG. 3 is a schematic diagram of multiple function modules according to an embodiment of the disclosure.

FIG. 4 is a flowchart of a smart charging method according to an embodiment of the disclosure.

FIG. 5 is a schematic diagram of determining a charging parameter according to an embodiment of the disclosure.

FIG. 6 is a schematic diagram of providing a power management notification according to an embodiment of the disclosure.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

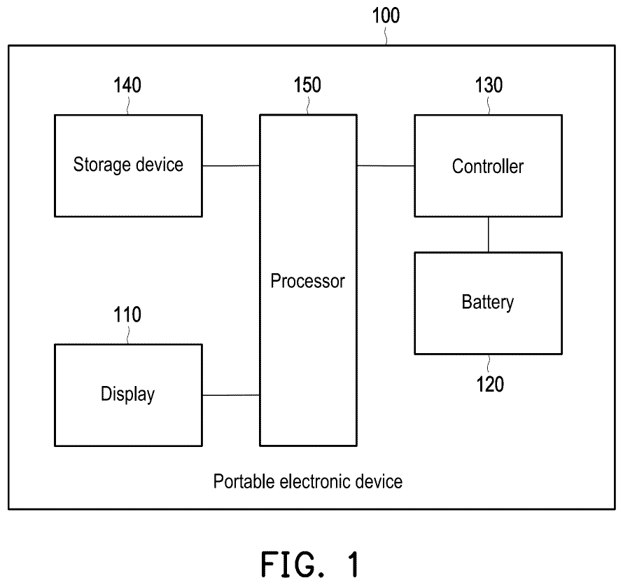

Referring to FIG. 1, the portable electronic device 100 may be, for example, a smartphone, a tablet, or a laptop, which is powered by an internal battery, but the disclosure is not limited thereto. The portable electronic device 100 is adapted to receive the direct current (DC) power required for operation from an external source (e.g., provided by a power adapter) and convert it into an operating power supply suitable for powering internal circuits and/or charging the battery 120. In one embodiment, the portable electronic device 100 includes a display 110, a battery 120, a controller 130, a storage device 140, and a processor 150, whose functions are described separately below, which is not limited here.

In one embodiment, the display 110 provides display function to show screens, such as Liquid Crystal Display (LCD), Light-Emitting Diode (LED) display, Field Emission Display (FED), Organic Light-Emitting Diode (OLED) display, or other types of displays, which are not limited in this disclosure.

The battery 120 is used as the main power supply source for the portable electronic device 100 when the portable electronic device 100 is not connected to an external AC power supply via a power adapter. When the portable electronic device 10 is connected to an external AC power supply, the battery 120 may perform charging. In some embodiments, the battery 120 may be a smart battery device with an internal control chip (not shown), which may provide battery information through a data bus (such as a system management bus, SMBus). The battery information may be data supporting the Smart Battery Data Specification (SBD Specification).

In some embodiments, the task of reading battery information from the battery 120 may be the responsibility of the controller 130, which is coupled between the processor 150 and the battery 120. After the controller 130 receives a command from the processor 150, the controller 130 may read the current battery information (such as remaining capacity data) from the battery 120, and then provide it to the processor 150. The controller 130 may be, for example, an embedded controller (EC) in the portable electronic device 100. The battery 120 may provide battery information to the controller 130 through a data bus, allowing the controller 130 to execute power management tasks according to the battery information.

The storage device 140 is used to store files, commands, codes, software modules and other data, which may be, for example, any type of fixed or removable random access memory (RAM), read-only memory (ROM), flash memory, hard disk or other similar devices, integrated circuits or combinations thereof.

In one embodiment, the processor 150 includes a Central Processing Unit (CPU), application processor (AP), or other programmable general-purpose or special-purpose microprocessor, Digital Signal Processor (DSP), programmable controller, Application Specific Integrated Circuits (ASIC), Programmable Logic Device (PLD), Graphics Processing Unit (GPU) or other similar devices or combinations of these devices, which is not limited here. The processor 150 may execute codes, software modules, commands, etc. recorded in the storage device 140 to implement the smart charging method of the embodiments disclosed herein. The above-mentioned software modules may be broadly interpreted to mean instructions, instruction sets, codes, program codes, programs, applications, software packages, threads, processes, functions, etc.

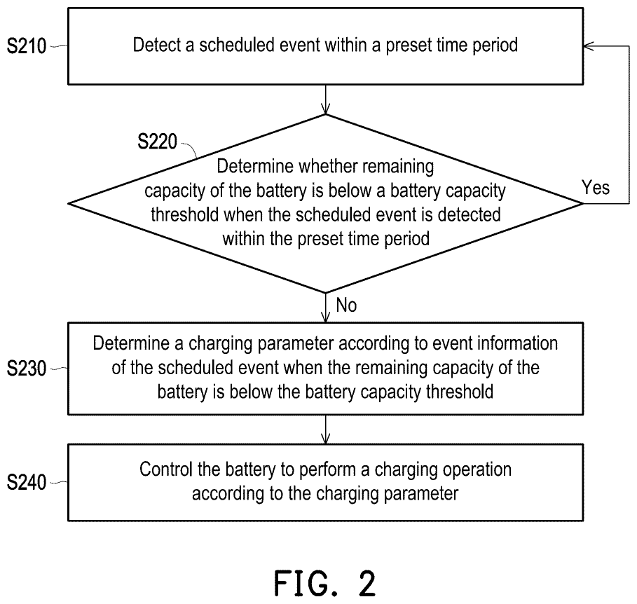

Referring to FIG. 1 and FIG. 2, the method of the embodiment is adapted to the portable electronic device 100 in the above-mentioned embodiment. The following will explain the detailed steps of the smart charging method of this embodiment in conjunction with the various components in the portable electronic device 100.

At step S210, the processor 150 may detect a scheduled event within a preset time period. That is, the processor 150 may check whether there are scheduled events that need to proceed within the preset time period (for example, within two hours). In some embodiments, the preset time period may be the charging time required for the battery 120 to charge from a remaining capacity of 0 to a fully charged status. In different embodiments, the scheduled event may include a user scheduled event, a system scheduled event, or a software scheduled event.

In some embodiments, the user scheduled events includes calendar events scheduled by the user, such as meetings or to-do items, etc. In some embodiments, the processor 150 may obtain a calendar in the portable electronic device 100. Then, based on a current time point, the processor 150 may detect whether the calendar records nay user scheduled event within the preset time period. For example, assuming the current time point is 9 a.m., the processor 150 may determine whether the calendar records any user scheduled event from 9 am to 11 am. If the calendar records a scheduled meeting at 10 am, the processor 150 may determine that a scheduled event within the preset time period is detected.

In some embodiments, the system scheduled event may be events or tasks managed by a scheduler built into the operating system (OS) (such as Windows' Task Scheduler), for example, regularly executed system maintenance, data backup, disk cleanup or software update operations, etc.

In some embodiments, the software scheduled event may be scheduled events set by a specific application or software. For example, regular scanning by antivirus software, automatic backup by backup software, or scheduled updates of certain software tools, etc.

At step S220, the processor 150 may determine whether the remaining capacity of the battery 120 is below a battery capacity threshold when the processor 150 may determine that a scheduled event within the preset time period is detected. The remaining capacity of the battery 120 may be a remaining capacity percentage. For example, assuming the battery capacity threshold is 80%, the processor 150 may determine whether the remaining capacity percentage of the battery 120 is below 80%. In some embodiments, the battery capacity threshold may be a fixed value, such as 80% or 90%, etc. Alternatively, in some embodiments, the battery capacity threshold may be a variable amount formulated according to event information.

At step S230, the processor 150 may determine a charging parameter according to the event information of the scheduled event when the remaining capacity of the battery 120 is below the battery capacity threshold. The above-mentioned charging parameter may be, for example, charging speed or charging current value, etc. The event information of the scheduled event may include an event occurrence time, an event duration time, or an estimated event power consumption degree. In various embodiments, the processor 150 may determine the charging parameter through table lookup or function calculation.

In some embodiments, the processor 150 may also decide the charging parameter according to the battery information of the battery 120. For example, the controller 130 may control the battery 120 to report battery information according to commands regulated by the smart battery data standard. The above-mentioned battery information may include whether the battery 120 operates in a chargeable state or non-chargeable state, current charging speed, remaining capacity, current charging current, or current charging voltage, etc. In some embodiments, when the remaining capacity of the battery 120 is below the battery capacity threshold, the processor 150 may control the battery 120 to operate in a fast charging mode or normal charging mode according to the event information of the scheduled event and the remaining capacity of the battery 120.

At step S240, the processor 150 controls the battery to perform a charging operation according to the charging parameter. In some embodiments, the processor 150 controls the battery 120 to perform a charging operation according to the charging parameter through the controller 130, which is not limited here. For example, the controller 130 may control the charging current of the battery 120 to increase or decrease. Alternatively, the controller 130 may control the battery 120 to switchably operate in a fast charging mode or normal charging mode.

In the embodiments disclosed herein, when the processor 150 detects a scheduled event and the remaining capacity of the battery 120 is too low, the processor 150 may dynamically decide the charging parameter and control the battery 120 to charge accordingly. Based on this, the situation where the portable electronic device 100 runs out of power during the execution of the scheduled event without connecting to an external power supply may be avoided.

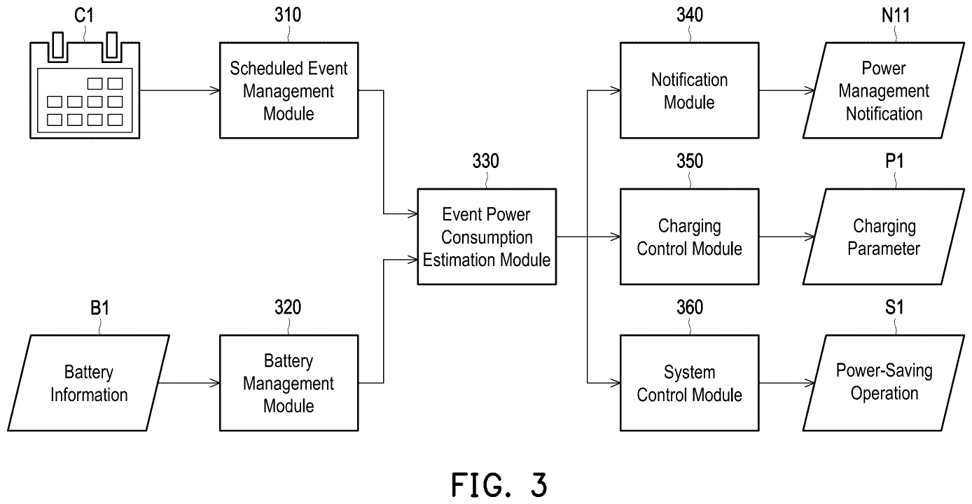

Referring to FIG. 3, which is a schematic diagram of multiple function modules of an embodiment of the disclosure. The portable electronic device 100 may include multiple function modules, which are a scheduled management module 310, a battery management module 320, an event power consumption estimation module 330, a notification module 340, a charging control module 350, and a system control module 360. In some embodiments, the intelligent charging method of this embodiment may be realized through the processor 150 executing the above-mentioned function modules recorded in the storage device 140. That is, the above-mentioned function modules may be implemented as multiple software/firmware modules.

The scheduled management module 310 may detect scheduled events. The scheduled management module 310 may access calendar data via the application programming interface (API) provided by the calendar C1, so that the scheduled management module 310 may read the event information of user scheduled events in the calendar. In addition, the scheduled management module 310 may also obtain event information of system scheduled events and software scheduled events through APIs of other applications or system event schedulers.

The battery management module 320 may request the battery 120 or the controller 130 to report the battery information B1 of the battery 120.

The event power consumption estimation module 330 may determine whether there is a scheduled event occurring within a preset time period. Furthermore, the event power consumption estimation module 330 may detect scheduled events within the preset time period according to the event information of scheduled events provided by the scheduled management module 310. In addition, the event power consumption estimation module 330 may determine the charging strategy of the battery 120 according to the event information of the scheduled event and the battery information B1. The event power consumption estimation module 330 may determine to enable a power-saving operation according to the event information of the scheduled event and the battery information B1. The event power consumption estimation module 330 may determine whether to provide a power management notification N11 to the user according to the battery information B1. The power management notification N11 may be used to notify the user about relevant measures to allow the scheduled event to complete execution. The power management notification N11 may remind the user to charge the portable electronic device 100, remind the user to save power, suggest the user to shorten the event duration length of the scheduled event, or provide power estimation after the scheduled event ends, but is not limited to the above content.

The notification module 340 may issue a power management notification N11 to the user according to the notification from the event power consumption estimation module 330. For example, the notification module 340 may control the display 110 to display the power management notification N11. Alternatively, the notification module 340 may control a light-emitting device to illuminate to provide the power management notification N11. The charging control module 350 may control the battery 120 to charge according to the charging strategy determined by the event power consumption estimation module 330. The system control module 360 may execute a power-saving operation S1 according to the notification from the event power consumption estimation module 330.

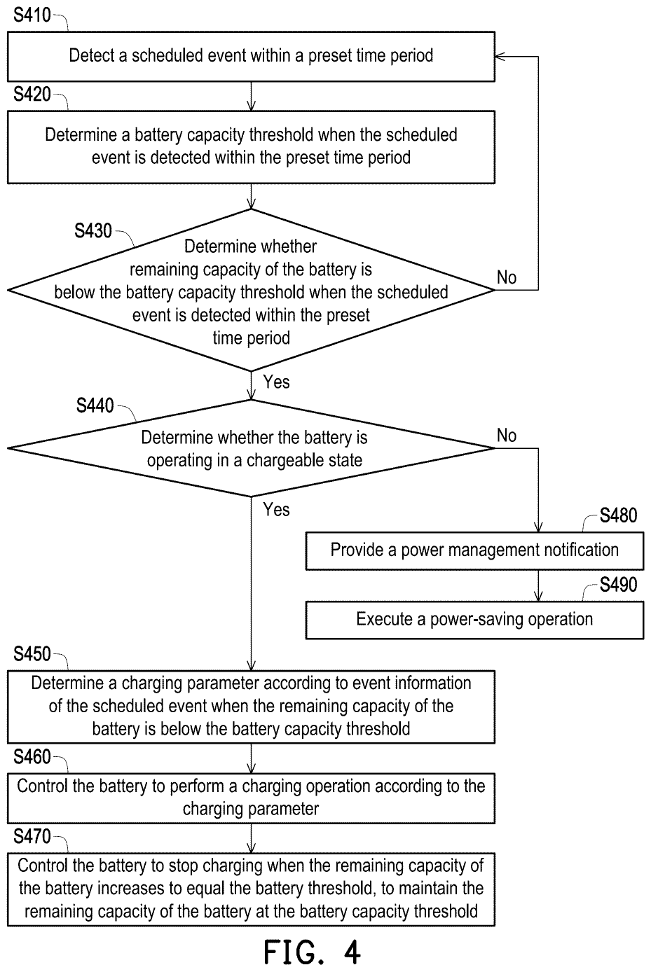

Referring to FIG. 1 and FIG. 4, the method of this embodiment is applicable to the portable electronic device 100 in the above embodiment, and the detailed steps of the smart charging method of this embodiment will be explained below in conjunction with the various components in the portable electronic device 100.

At step S410, the processor 150 may detect a scheduled event within a preset time period. At step S420, when a scheduled event within the preset time period is detected, the processor 150 may determine a battery capacity threshold according to the event information of the scheduled event. That is, in some embodiments, the battery capacity threshold may be dynamically determined according to the event information of the scheduled event.

In some embodiments, the processor 150 may determine the battery capacity threshold according to an estimated power consumption degree and an event duration time of the scheduled event. The battery capacity threshold is positively correlated with the event duration time. That is, the longer the event duration time, the higher the battery capacity threshold. The reason is that the longer the event duration time, the more power is needed to support the operation of the scheduled event. The event duration time may be, for example, the length of a meeting time, the estimated time for software updates, or the estimated time for data backup. In addition, the battery capacity threshold is positively correlated with the estimated power consumption degree. That is, the higher the estimated power consumption degree, the higher the battery capacity threshold. The reason is that the higher the estimated power consumption degree, the more power is needed to support the operation of the scheduled event. The processor 150 may identify the estimated power consumption degree of the scheduled event according to pre-established rules. For example, the processor 150 may obtain the estimated power consumption degree of a certain scheduled event as n watt-hours (Wh) through table lookup. Then, through table lookup or function calculation, the processor 150 may determine the battery capacity threshold according to the estimated power consumption degree and the event duration time of the scheduled event.

In some embodiments, the estimated power consumption degree of the scheduled event may be the power consumption per unit time of a certain application program. The power consumption per unit time of different application programs may be obtained through experiments or big data analysis. The battery capacity threshold may be calculated according to the following equation (1) and equation (2).

$$Event expected power consumption = P 1 \times Δ ED \qquad equation ( 1 )$$

$$Battery capacity threshold = Event expected power consumption + β \qquad equation ( 2 )$$

wherein P1 is power consumption per unit time, ΔED is event duration time, β is an adjustment value greater than or equal to 0.

For example, assuming that a scheduled event may perform by executing a first application program, the processor 150 may obtain the event expected power consumption of the scheduled event according to the power consumption per unit time of the first application program and the event duration time of the first application program. Assuming that a scheduled event may use a first application program and a second application program, the processor 150 may first calculate the sum of the power consumption per unit time of the first application program and the power consumption per unit time of the second application program, then multiply the above sum of power consumption per unit time by the event duration time to obtain the event expected power consumption of the scheduled event. Afterwards, the processor 150 may determine the battery capacity threshold to be the event expected power consumption. Alternatively, the processor 150 may determine the battery capacity threshold to be the event expected power consumption plus the adjustment value β.

At step S430, when a scheduled event within a preset time period is detected, the processor 150 may determine whether the remaining capacity of the battery 120 is below a battery capacity threshold. At step S440 (step S430 is determined as yes), when the remaining capacity of the battery 120 is below the battery capacity threshold, the processor 150 may determine whether the battery 120 is operating in a chargeable state. That is, when the remaining capacity of the battery 120 is below the battery capacity threshold, the processor 150 may determine whether the battery 120 is connected to an external power supply (such as an external AC power supply or an external DC power supply) and operating in a chargeable state. When the battery 120 is connected to an external power supply, the battery 120 operates in a chargeable state. When the battery 120 is not connected to an external power supply, the battery 120 operates in a non-chargeable state.

At step S450 (step S440 is determined as yes), when the remaining capacity of the battery 120 is below the battery capacity threshold and the battery 120 operates in a chargeable state, the processor 150 may determine a charging parameter according to the event information of the scheduled event.

In some embodiments, the processor 150 may determine a charging speed according to a time interval between a current time point and an event occurrence time of the scheduled event. If the time interval between the current time point and the event occurrence time of the scheduled event is less than a charging time threshold, the processor 150 may determine the charging speed to be a first value. If the time interval between the current time point and the event occurrence time of the scheduled event is not less than a charging time threshold, the processor 150 may determine the charging speed to be a second value. The first value is greater than the second value. That is, if the time interval between the current time point and the event occurrence time of the scheduled event is too short, the processor 150 may increase the charging speed to allow the battery 120 to store as much power as possible before the event occurrence time.

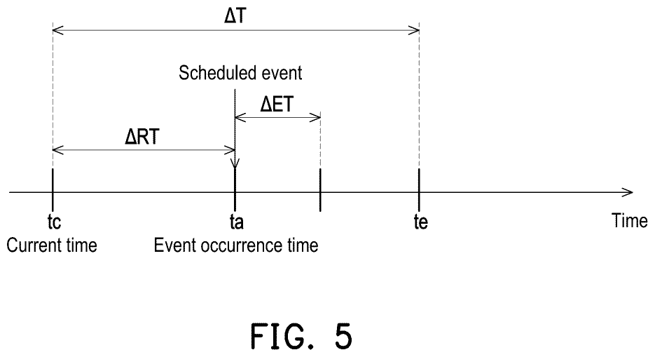

Referring to FIG. 5, which is a schematic diagram of determining a charging parameter according to an embodiment of this disclosure. The processor 150 may detect whether there is any scheduled event within a preset time period ΔT at the current time tc. That is, the processor 150 may determine whether any scheduled event will occur within the preset time period ΔT between the current time tc and the end time te. In this example, the processor 150 may detect the scheduled event A within the preset time period ΔT. The processor 150 may determine the battery capacity threshold according to the event duration time ΔET of the scheduled event A. When the remaining capacity of the battery 120 is below the battery capacity threshold, the processor 150 may determine the charging speed according to the time interval ΔRT between the current time point tc and the event occurrence time ta of the scheduled event A, and control the battery 120 to charge according to the charging speed.

At step S460, the processor 150 may control the battery 120 to perform a charging operation according to the charging parameter. At step S470, when the remaining capacity of the battery 120 increases to equal the battery capacity threshold, the processor 150 may control the battery 120 to stop charging, to maintain the remaining capacity of the battery 120 at the battery capacity threshold. That is, the processor 150 may disable the battery 120 from charging to a fully charged status, but instead controls the remaining capacity of the battery 120 to maintain at the battery capacity threshold. In this way, it may avoid the battery 120 maintaining at a fully charged status and accelerating the battery aging status. That is, compared with returning the battery 120 to a fully charged status every time, by maintaining the remaining capacity of the battery 120 within a specific power range, the embodiment of this disclosure may reduce the number of charging actions and delay the degree of aging of the battery 120.

Therefore, even though the processor 150 controls the remaining capacity of the battery 120 to maintain at the battery capacity threshold, the processor 150 may still decide the charging strategy of the battery 120 according to the detection of the scheduled event, which may avoid encountering the predicament of insufficient power to complete the scheduled event due to the removal of the external power supply.

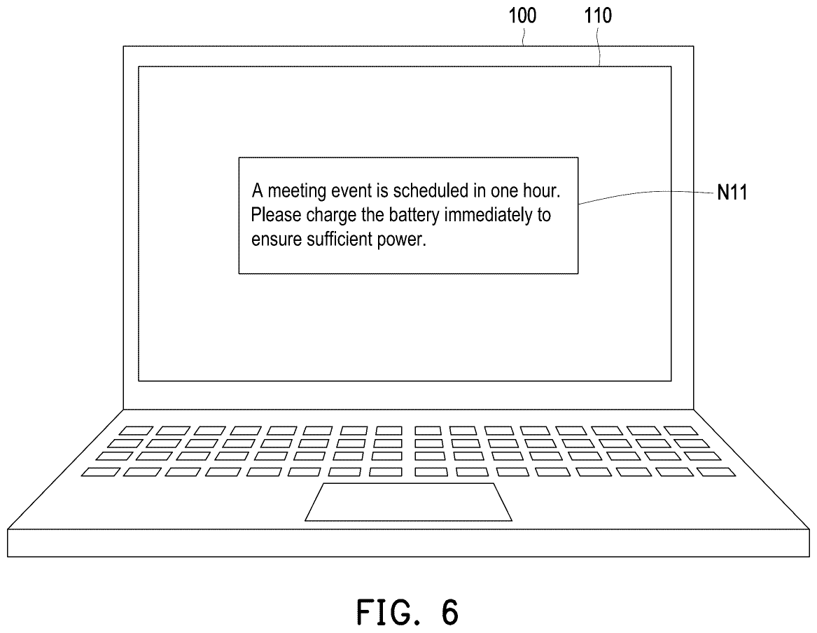

At step S480 (step S440 is determined as no), when the battery 120 is not operating in a chargeable state, the processor 150 may provide a power management notification. Referring to FIG. 6, which is a schematic diagram of providing a power management notification according to an embodiment of this disclosure. The processor 150 may display the power management notification N11 through the display 110 using a pop-up window. The power management notification N11 may include the event occurrence time of the scheduled event, and is used to notify the user to connect the portable electronic device 100 to an external power supply for charging.

At step S490 (step S440 is determined as no), when the battery 120 is not operating in a chargeable state, the processor 150 may execute a power-saving operation. In some embodiments, the power-saving operation may include turning off at least one idle application, reducing the display brightness of the display 110, reducing the volume of the speaker, turning off communication functions, or removing external storage devices and other related operations that may save power consumption. The power-saving operation may also include reducing the working frequency of the central processor or graphics processor, or reducing the charging current provided to external devices (USB external storage device). Through the execution of the power-saving operation, the speed of power level reduction of the battery 120 may be reduced.

In summary, in the embodiment of this disclosure, when a scheduled event is detected within a preset time period, it may be determined whether the remaining capacity of the battery is sufficient for the portable electronic device to complete the scheduled event. And, when it is determined that the remaining capacity of the battery is not enough for the portable electronic device to complete the scheduled event, charging parameters may be determined according to the event information of the scheduled event, so that the battery may be charged according to these charging parameters until the remaining capacity equals the battery capacity threshold. By maintaining the remaining capacity of the battery within a specific power range, the aging speed of the battery may be delayed. And, it may ensure that the remaining usable time of the battery can meet the target requirements.

It will be apparent to those skilled in the art that various modifications and variations can be made to the structure of the present invention without departing from the scope or spirit of the disclosure. In view of the foregoing, it is intended that the disclosure cover modifications and variations of this invention provided they fall within the scope of the following claims and their equivalents.

What is claimed is:

1. A smart charging method, adapted to a portable electronic device comprising a battery, the method comprising:
detecting a scheduled event within a preset time period;
determining whether remaining capacity of the battery is below a battery capacity threshold when the scheduled event within the preset time period is detected;
determining a charging parameter according to event information of the scheduled event when the remaining capacity of the battery is below the battery capacity threshold; and
controlling the battery to perform a charging operation according to the charging parameter.

2. The smart charging method as claimed in claim 1, wherein after the step of controlling the battery to perform the charging operation according to the charging parameter, the method further comprising:
controlling the battery to stop charging when the remaining capacity of the battery increases to equal to the battery capacity threshold, to maintain the remaining capacity of the battery at the battery capacity threshold.

3. The smart charging method as claimed in claim 2, further comprising:
determining the battery capacity threshold according to the event information of the scheduled event when the scheduled event within the preset time period is detected.

4. The smart charging method as claimed in claim 3, wherein the step of determining the battery capacity threshold according to the event information of the scheduled event comprising:
determining the battery capacity threshold according to an estimated power consumption degree and an event duration time of the scheduled event,
wherein the battery capacity threshold is positively correlated with the event duration time, and the battery capacity threshold is positively correlated with the estimated power consumption degree.

5. The smart charging method as claimed in claim 1, wherein the step of determining the charging parameter according to the event information of the scheduled event when the remaining capacity of the battery is below the battery capacity threshold comprising:
determining a charging speed according to a time interval between a current time point and an event occurrence time of the scheduled event.

6. The smart charging method as claimed in claim 1, wherein the scheduled event includes a system scheduled event or a software scheduled event.

7. The smart charging method as claimed in claim 1, wherein the scheduled event comprises a user scheduled event, and the step of detecting the scheduled event within the preset time period comprising:
acquiring a calendar in the portable electronic device; and
detecting whether the calendar records the user scheduled event within the preset time period based on a current time point.

8. The smart charging method as claimed in claim 1, further comprising:
determining whether the battery is operating in a chargeable state when the remaining capacity of the battery is below the battery capacity threshold; and
providing a power management notification when the battery is not operating in the chargeable state.

9. The smart charging method as claimed in claim 8, further comprising:
executing a power-saving operation when the battery is not operating in the chargeable state.

10. A portable electronic device, comprising:
a battery;
a storage device, recording a plurality of instructions;
a process, coupled to the battery and the storage device, executing the instructions and configured to:
detect a scheduled event within a preset time period;
determine whether remaining capacity of the battery is below a battery capacity threshold when the scheduled event within the preset time period is detected;
determine a charging parameter according to event information of the scheduled event when the remaining capacity of the battery is below the battery capacity threshold; and
control the battery to perform a charging operation according to the charging parameter.
